(19) United States
(12) Patent Application Publication
(10) Pub. No.: US 2023/0196588 A1
(43) Pub. Date: Jun. 22, 2023

(54) DEVICE, METHOD, AND COMPUTER PROGRAM FOR TRACKING

(71) Applicant: TOYOTA JIDOSHA KABUSHIKI KAISHA, Toyota-shi (JP)

(72) Inventor: Satoshi Takeyasu, Urawa-shi (JP)

(21) Appl. No.: 18/067,080

(22) Filed: Dec. 16, 2022

(30) Foreign Application Priority Data
Dec. 21, 2021 (JP) 2021-207242

(51) Int. Cl. G06T 7/246; G06T 7/70

(52) U.S. Cl. CPC G06T 7/248; G06T 7/70; G06T 2207/30261

(57) ABSTRACT

A tracking device includes a processor configured to detect regions each having a confidence score, which indicates how likely a predetermined object is represented, not less than a predetermined detection threshold as candidate regions, determine whether one of the candidate regions can be associated with the predetermined object, based on optical flow between an object region representing the predetermined object in a past image earlier than the image and each candidate region, increment a tracking count of the object by one when the association can be made, set the detection threshold applied to a subsequent image later than the image at a first value when the tracking count is not greater than a predetermined number, and set the detection threshold applied to the subsequent image at a second value lower than the first value when the tracking count is greater than the predetermined number.

### FIELD

The present invention relates to a device, a method, and a computer program for tracking an object represented in images.

### BACKGROUND

Techniques to track an object detected from time-series images generated by a camera have been proposed (see Japanese Unexamined Patent Publications JP2020-52695A and JP2017-102824A).

An object detection device disclosed in JP2020-52695A tracks a first object detected in a sensor signal preceding the latest of time-series sensor signals obtained by a sensor to detect a passed region in the latest sensor signal passed by the first object. For each region in the latest sensor signal, the object detection device controls a confidence score threshold applied to a confidence score for a second object represented in the region, depending on whether the region is included in the passed region. The object detection device detects the second object in a region having a confidence score not less than the confidence score threshold.

A tracking device disclosed in JP2017-102824A calculates optical flow using multiple images and detects the position and the moving direction of a moving object, based on the calculated optical flow. The tracking device also detects the position and the moving direction of the moving object, based on multiple overhead images generated based on the images. The tracking device further detects the position and the moving direction of the moving object by integrating the results of detection thereof based on the optical flow and based on the overhead images. In addition, the tracking device estimates a future position and a future moving direction of a moving target to be tracked determined based on the results of detection. The tracking device then identifies the position of the moving target by tracking the moving target, using the position estimated for the moving target, the position of the moving object detected based on the overhead images, or the position of the moving object detected based on integration of the results of detection.

### SUMMARY

It may become difficult to detect an object in an image generated at a point of time while tracking the object, depending on the positional relationship between a camera and the object being tracked. In such a case, a tracking device tracking the object may fail to detect a region representing the object being tracked, and as a result, failing to track the object.

It is an object of the present invention to provide a tracking device that can appropriately keep tracking an object represented in time-series images.

According to an embodiment, a tracking device is provided. The tracking device includes: a processor configured to: detect at least one region having a confidence score, which indicates how likely a predetermined object is represented, not less than a predetermined detection threshold in an image generated by a camera as at least one candidate region representing the predetermined object by inputting the image into a classifier, determine whether one of the at least one candidate region can be associated as a region representing the predetermined object, based on optical flow between an object region representing the predetermined object in a past image generated by the camera earlier than the image and each of the at least one candidate region, increment a tracking count of the predetermined object by one when the association can be made, set the detection threshold applied to a subsequent image obtained by the camera later than the image at a first value when the tracking count is not greater than a predetermined number, and set the detection threshold applied to the subsequent image at a second value lower than the first value when the tracking count is greater than the predetermined number.

The processor of the tracking device is preferably further configured to detect a region the confidence score of which is not less than a third value lower than the second value from the image as an additional candidate region when the tracking count is greater than the predetermined number. The processor preferably determines whether the additional candidate region can be associated with the predetermined object as a region representing the predetermined object, based on optical flow between the object region in the past image and the additional candidate region, when it is determined that none of the at least one candidate region detected from the image is a region representing the predetermined object.

The processor of the tracking device is preferably further configured to estimate the position of the predetermined object in the subsequent image from the object region in each of past images generated by the camera earlier than the image, and set a region including the estimated position as a region to which the detection threshold having the second value is applied. The past images are generated while the predetermined object the tracking count of which is greater than the predetermined number is tracked.

According to another embodiment, a method for tracking is provided. The method includes: detecting at least one region having a confidence score, which indicates how likely a predetermined object is represented, not less than a predetermined detection threshold in an image generated by a camera as at least one candidate region representing the predetermined object by inputting the image into a classifier, determining whether one of the at least one candidate region can be associated as a region representing the predetermined object, based on optical flow between an object region representing the predetermined object in a past image generated by the camera earlier than the image and each of the at least one candidate region; incrementing a tracking count of the predetermined object by one when the association can be made; setting the detection threshold applied to a subsequent image obtained by the camera later than the image at a first value when the tracking count is not greater than a predetermined number; and setting the detection threshold applied to the subsequent image at a second value lower than the first value when the tracking count is greater than the predetermined number.

According to still another embodiment, a non-transitory recording medium that stores a computer program for tracking is provided. The computer program includes instructions causing a computer to execute a process including: detecting at least one region having a confidence score, which indicates how likely a predetermined object is represented, not less than a predetermined detection threshold in an image generated by a camera as at least one candidate region representing the predetermined object by inputting the image into a classifier; determining whether one of the at least one candidate region can be associated as a region representing the predetermined object, based on optical flow between an object region representing the predetermined object in a past image generated by the camera earlier than the image and each of the at least one candidate region; incrementing a tracking count of the predetermined object by one when the association can be made; setting the detection threshold applied to a subsequent image obtained by the camera later than the image at a first value when the tracking count is not greater than a predetermined number; and setting the detection threshold applied to the subsequent image at a second value lower than the first value when the tracking count is greater than the predetermined number.

The tracking device according to the present disclosure has an advantageous effect of being able to appropriately keep tracking an object represented in time-series images.

### BRIEF DESCRIPTION OF DRAWINGS

FIG. 1 schematically illustrates the configuration of a vehicle control system equipped with a tracking device.

FIG. 2 illustrates the hardware configuration of an electronic control unit, which is an embodiment of the tracking device.

FIG. 3 is a functional block diagram of a processor of the electronic control unit, related to a vehicle control process including a tracking process.

FIG. 4A is a schematic diagram for explaining a tracking process according to a comparative example.

FIG. 4B is a schematic diagram for explaining the tracking process according to the embodiment.

FIG. 5 is an operation flowchart of the vehicle control process including the tracking process.

### DESCRIPTION OF EMBODIMENTS

A tracking device, a method for tracking executed by the tracking device, and a computer program for tracking will now be described with reference to the attached drawings. The tracking device inputs each of time-series images generated by an image capturing unit into a classifier to detect an object to be detected, and tracks the detected object. To this end, the tracking device increments a tracking count of the object by one whenever the number of images in which the object can be tracked increases. Depending on the tracking count, the tracking device controls a detection threshold to be compared with a confidence score outputted by the classifier and indicating how likely the object to be detected is represented. In particular, the tracking device sets the detection threshold applied for an object the tracking count of which is greater than a predetermined number at a value lower than the value for the case that the tracking count is not greater than the predetermined number. This makes it easy for the tracking device to keep tracking an object even if it becomes difficult to detect the object from an image for some reason during tracking the object.

The following describes an example in which the tracking device is applied to a vehicle control system. In this example, the tracking device executes a tracking process on images obtained by a camera mounted on a host vehicle to track another vehicle traveling in an area around the host vehicle (a vehicle in the surrounding area will hereafter be referred to as a “target vehicle” for convenience of description). The result of tracking is used for driving control of the host vehicle. A target vehicle is an example of a predetermined object to be detected and tracked.

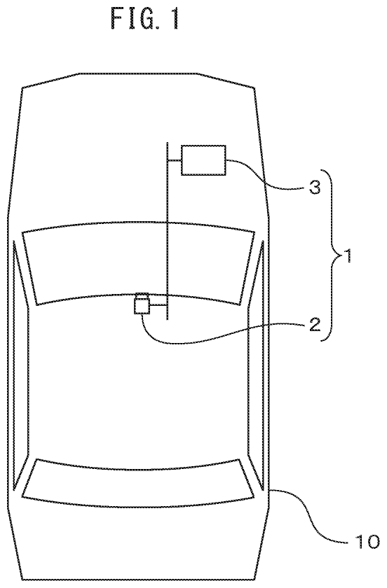

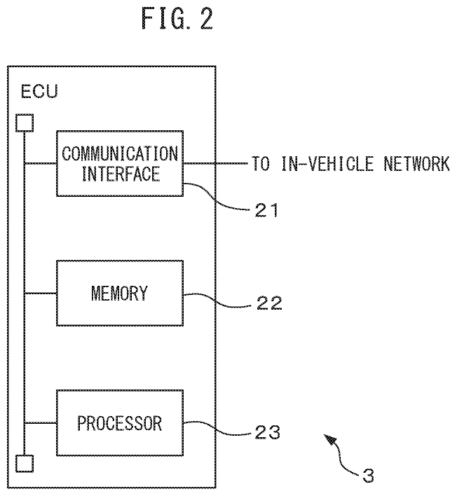

FIG. 1 schematically illustrates the configuration of a vehicle control system equipped with the tracking device. FIG. 2 illustrates the hardware configuration of an electronic control unit, which is an embodiment of the tracking device. In the present embodiment, the vehicle control system 1, which is mounted on the vehicle 10 (i.e., the host vehicle) and controls the vehicle 10, includes a camera 2 for taking pictures of the surroundings of the vehicle 10, and an electronic control unit (ECU) 3, which is an example of the tracking device. The camera 2 is communicably connected to the ECU 3 via an in-vehicle network conforming to a standard such as a controller area network. The vehicle control system 1 may further include a storage device (not illustrated) that stores map information used for autonomous driving control of the vehicle 10 and representing lane-dividing lines and the positions and the types of features. The vehicle control system 1 may further include a range sensor (not illustrated), such as LiDAR or radar. The vehicle control system 1 may further include a receiver (not illustrated) for determining the position of the vehicle 10 in conformity with a satellite positioning system, such as a GPS receiver. The vehicle control system 1 may further include a navigation device (not illustrated) for searching for a planned travel route of the vehicle 10.

The camera 2, which is an example of the image capturing unit, includes a two-dimensional detector constructed from an array of optoelectronic transducers, such as CCD or C-MOS, having sensitivity to visible light and a focusing optical system that forms an image of a target region of capturing on the two-dimensional detector. The camera 2 is mounted, for example, in the interior of the vehicle 10 so as to be oriented to the front of the vehicle 10. The camera 2 captures a region in front of the vehicle 10 every predetermined capturing period (e.g., 1/30 to 1/10 seconds), and generates images representing the region. The images obtained by the camera 2 may be color or grayscale images. The vehicle 10 may include multiple cameras taking pictures in different orientations or having different focal lengths.

Whenever an image is generated, the camera 2 outputs the generated image and the time of capturing (i.e., the time of generation of the image) to the ECU 3 via the in-vehicle network.

The ECU 3 controls the vehicle 10. In the present embodiment, the ECU 3 detects a target vehicle from time-series images obtained by the camera 2. In addition, the ECU 3 tracks the target vehicle, based on the result of detection of the target vehicle from the time-series images. The ECU 3 controls the vehicle 10 to automatically drive the vehicle 10 so as to avoid collision with the target vehicle, based on the result of tracking the target vehicle. To achieve this, the ECU 3 includes a communication interface 21, a memory 22, and a processor 23.

The communication interface 21, which is an example of a communication unit, includes an interface circuit for connecting the ECU 3 to the in-vehicle network. In other words, the communication interface 21 is connected to the camera 2 via the in-vehicle network. Whenever an image is received from the camera 2, the communication interface 21 passes the received image to the processor 23.

The memory 22, which is an example of a storage unit, includes, for example, volatile and nonvolatile semiconductor memories, and stores various types of data used in a tracking process executed by the processor 23 of the ECU 3. As such data, the memory 22 stores, for example, parameters representing information on the camera 2, such as the focal length, the imaging direction, and the height of the mounted position of the camera 2, and various parameters for defining a classifier used for detecting a target vehicle. The memory 22 also stores various types of information used for estimating the distance to a detected target vehicle. For example, the memory 22 stores standard widths of respective types of vehicles (hereafter, “standard vehicle widths”). In addition, the memory 22 stores images received from the camera 2 together with the times of capturing for a certain period. Further, the memory 22 stores various types of data generated during the tracking process, such as a detection list including information on target vehicles being tracked, for a certain period. The memory 22 may further store information used for travel control of the vehicle 10, such as map information.

The processor 23, which is an example of a control unit, includes one or more central processing units (CPUs) and a peripheral circuit thereof. The processor 23 may further include another operating circuit, such as a logic-arithmetic unit, an arithmetic unit, or a graphics processing unit. During travel of the vehicle 10, the processor 23 executes a vehicle control process including a tracking process at predetermined intervals (e.g., several tens of milliseconds to a hundred milliseconds). The processor 23 controls the vehicle 10 to automatically drive the vehicle 10, based on the result of tracking a detected target vehicle.

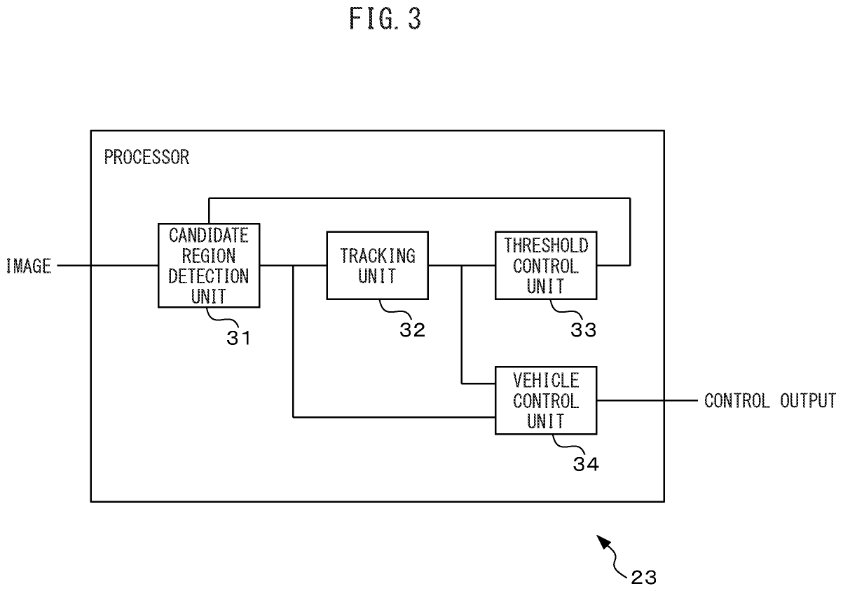

FIG. 3 is a functional block diagram of the processor 23 of the ECU 3, related to a vehicle control process including a tracking process. The processor 23 includes a candidate region detection unit 31, a tracking unit 32, a threshold control unit 33, and a vehicle control unit 34. These units included in the processor 23 are functional modules, for example, implemented by a computer program executed by the processor 23, or may be dedicated operating circuits provided in the processor 23. Of these units included in the processor 23, the candidate region detection unit 31, the tracking unit 32, and the threshold control unit 33 execute the tracking process. In the case that the vehicle 10 includes multiple cameras, the processor 23 may execute the tracking process for each camera, based on images obtained by the camera.

The candidate region detection unit 31 inputs the latest image received by the ECU 3 from the camera 2 into a classifier to calculate a confidence score indicating how likely a target vehicle is represented for each of multiple regions in the image. Of the multiple regions, the candidate region detection unit 31 detects individual regions each having a confidence score not less than a predetermined detection threshold as candidate regions representing target vehicles.

As the classifier, the candidate region detection unit 31 can use, for example, a “deep neural network (DNN).” More specifically, the DNN used as the classifier may be one having architecture of a convolutional neural network (CNN) type, such as Single Shot MultiBox Detector (SSD) or Faster R-CNN. Such a classifier is trained in advance in accordance with a predetermined training technique, such as backpropagation, with a large number of training images representing vehicles so as to detect a target vehicle from an image. More specifically, the classifier is trained in advance so that a confidence score calculated for a region representing a target vehicle is higher than a confidence score calculated for a region that does not represent a target vehicle. Use of a DNN trained in this way enables the candidate region detection unit 31 to detect a candidate region from an image appropriately.

In addition, the classifier outputs the result of identification of the type of the target vehicle (e.g., a passenger vehicle, a large-size vehicle, or a motorcycle) for each region in the image.

The candidate region detection unit 31 compares the confidence score calculated by the classifier for each region with a detection threshold that is set by the threshold control unit 33 for the region. The candidate region detection unit 31 then detects a region having a confidence score not less than the detection threshold as a candidate region. The detection threshold is set at a first value (e.g., 0.8) or a second value (e.g., 0.7) lower than the first value. A low-threshold region, where the detection threshold is set at the second value for a certain type, is set by the threshold control unit 33. Thus, the candidate region detection unit 31 uses the second value as the detection threshold for a region included in a low-threshold region and representing a target vehicle of the type for which the second value is applied in the low-threshold region, out of the regions whose confidence scores are calculated. The candidate region detection unit 31 may determine, for example, a region overlapping with a low-threshold region at a predetermined ratio (e.g., 0.7 to 1.0) or more as a region included in the low-threshold region. The candidate region detection unit 31 outputs information indicating the positions and the areas of the detected individual candidate regions, the types of target vehicles represented in the candidate regions, and the calculated confidence scores to the tracking unit 32 and the vehicle control unit 34. The information indicating the positions and the areas of the candidate regions includes, for example, the coordinates of the upper left and the lower right ends of the candidate regions.

In addition, the candidate region detection unit 31 determines a region included in a low-threshold region and representing a target vehicle of the type for which the second value is applied in the low-threshold region as an additional candidate region when the confidence score calculated for the region is not less than a third value. The third value is set at a value (e.g., 0.6) lower than the second value. The candidate region detection unit 31 then outputs information indicating the positions and the areas of the detected individual additional candidate regions, the types of target vehicles represented in the additional candidate regions, and the calculated confidence scores to the tracking unit 32 and the vehicle control unit 34.

The classifier may be trained in advance to detect not only target vehicles but also other objects that may affect driving control of the vehicle 10. The candidate region detection unit 31 may determine that such an object is represented in a region where the confidence score calculated for the object by inputting an image into the classifier is not less than the detection threshold having the first value. The candidate region detection unit 31 may then output information indicating the type of the detected object and the region representing the object to the vehicle control unit 34. Such objects include at least moving objects, such as humans; road markings, such as lane-dividing lines; features on or around roads, such as curbstones and guard rails; or signposts.

For each detected candidate region, the tracking unit 32 determines whether the candidate region can be associated with a target vehicle being tracked that is detected from a past image generated by the camera 2 earlier than the image from which the candidate region is detected. Specifically, for each candidate region, the tracking unit 32 calculates optical flow based on a region representing a target vehicle being tracked (hereafter also referred to as an “object region”) in the past image and the candidate region, and determines whether the association can be made, based on the optical flow. The tracking unit 32 then enters a candidate region that can be associated with a target vehicle being tracked in a detection list in association with the target vehicle as the object region representing the target vehicle, and increments a tracking count of the target vehicle by one. In addition, the tracking unit 32 determines a candidate region that cannot be associated with any target vehicle being tracked and that has a confidence score not less than the first value of the detection threshold as an object region representing a newly detected target vehicle. The tracking unit 32 then enters information indicating the target vehicle represented in the object region and the region representing the target vehicle in the detection list as a target vehicle whose tracking is newly started. At this entry, the tracking unit 32 sets the tracking count of the target vehicle whose tracking is newly started at one. Additionally, the tracking unit 32 finishes tracking a target vehicle being tracked that cannot be associated with any candidate region in images obtained in a preceding certain period.

For each target vehicle being tracked, the tracking unit 32 detects multiple characteristic points in accordance with a predetermined tracking technique from the object region representing the target vehicle (hereafter, the “region of interest”) in the latest past image from which the target vehicle is detected. For each target vehicle being tracked, the tracking unit 32 then calculates optical flow between the detected characteristic points and the candidate regions, and identifies a candidate region matching the region of interest the best, based on the calculated optical flow. To this end, the tracking unit 32 may select only candidate regions representing target vehicles of the same type as the target vehicle represented in the region of interest as candidate regions regarding which the optical flow is calculated. When the difference between the identified candidate region and the region of interest is not greater than a predetermined difference threshold, the tracking unit 32 associates the identified candidate region with the target vehicle represented in the region of interest. As the predetermined tracking technique, the tracking unit 32 can use, for example, the Lucas-Kanade method, the Kanade-Lucas-Tomasi (KLT) method, or a technique based on a Mean-Shift search. At detecting characteristic points, the tracking unit 32 can use a filter for detecting characteristic points used in the predetermined tracking technique, such as Harris operator or SIFT descriptor. The difference is calculated in accordance with the predetermined tracking technique, e.g., as that square error of pixel values between the characteristic points in the region of interest and the corresponding points in the candidate region which is minimized when the optical flow is calculated. In this way, the tracking unit 32 associates only a candidate region having a confidence score not less than the detection threshold having the first value with a target vehicle the tracking count of which is not greater than a predetermined number. However, with a target vehicle the tracking count of which is greater than the predetermined number, the tracking unit 32 can also associate a candidate region having a confidence score not less than the detection threshold having the second value. For this reason, the tracking unit 32 can keep tracking a target vehicle that has been tracked for a certain period and that is probably represented in the latest image, even if it becomes difficult to detect the target vehicle from the latest image. The predetermined number is set at two or greater, e.g., five to ten.

In some cases, there is no candidate region that can be associated with a region of interest representing a target vehicle the tracking count of which is greater than the predetermined number by the above-described process. In such a case, the tracking unit 32 determines whether an additional candidate region can be associated with the region of interest, based on optical flow between the region of interest and the additional candidate region. To this end, the tracking unit 32 determines a point in the additional candidate region such that the difference between the pixel values of an individual characteristic point detected from the region of interest and the point in the additional candidate region based on the optical flow is within a predetermined tolerance, as the point corresponding to the characteristic point. For each characteristic point, the tracking unit 32 may set a block of characteristic points including a predetermined number of pixels (e.g., a block of 3-by-3 pixels) centered at the characteristic point. The tracking unit 32 calculates the sum of the absolute values of the differences between the values of corresponding pixels of the block of characteristic points and a corresponding block in the additional candidate region based on the optical flow. When the sum of the absolute values of the differences between the pixel values is within a predetermined tolerance, the tracking unit 32 determines the pixel at the center of the corresponding block as the point corresponding to the characteristic point. When the ratio of the number of characteristic points whose corresponding points can be identified to the total number of characteristic points detected from the region of interest is not less than a predetermined ratio, the tracking unit 32 may associate the additional candidate region with the target vehicle represented in the region of interest. By determining whether such an additional candidate region can be associated with a target vehicle being tracked, the tracking unit 32 can keep tracking the target vehicle even if it becomes particularly difficult to detect the target vehicle in the latest image.

The tracking unit 32 stores the updated detection list and the tracking counts of the target vehicles being tracked in the memory 22 and notifies them to the threshold control unit 33.

For each target vehicle being tracked, the threshold control unit 33 sets the detection threshold applied to the target vehicle in the image obtained next to the image from which the candidate regions are detected (the former image will hereafter be referred to as the “subsequent image”).

In the present embodiment, the threshold control unit 33 sets the detection threshold for a target vehicle the tracking count of which is not greater than the predetermined number at a first value. In contrast, the threshold control unit 33 sets the detection threshold for a target vehicle the tracking count of which is greater than the predetermined number at a second value lower than the first value. The threshold control unit 33 then estimates a region supposed to represent the target vehicle in the subsequent image by referring to the detection list, and determines the estimated region as a low-threshold region. For example, the threshold control unit 33 applies a prediction process to the object regions representing the target vehicle in the respective past images during tracking and entered in the detection list to estimate a region supposed to represent the target vehicle in the subsequent image. As such a prediction process, the threshold control unit 33 can use a Kalman filter. Alternatively, the threshold control unit 33 may apply a predetermined extrapolation process to the object regions representing the target vehicle in the respective past images during tracking to estimate a region supposed to represent the target vehicle in the subsequent image. By setting a low-threshold region to which the detection threshold having the second value is applied in the subsequent image in this way, a detection threshold having an appropriate value can be applied for each target vehicle even if there are target vehicles tracked different numbers of times.

For each target vehicle being tracked, the threshold control unit 33 notifies the candidate region detection unit 31 and the tracking unit 32 of the detection threshold applied to the subsequent image. The threshold control unit 33 also notifies the candidate region detection unit 31 of information indicating the low-threshold region for each target vehicle the tracking count of which is greater than the predetermined number and information indicating the type of the target vehicle.

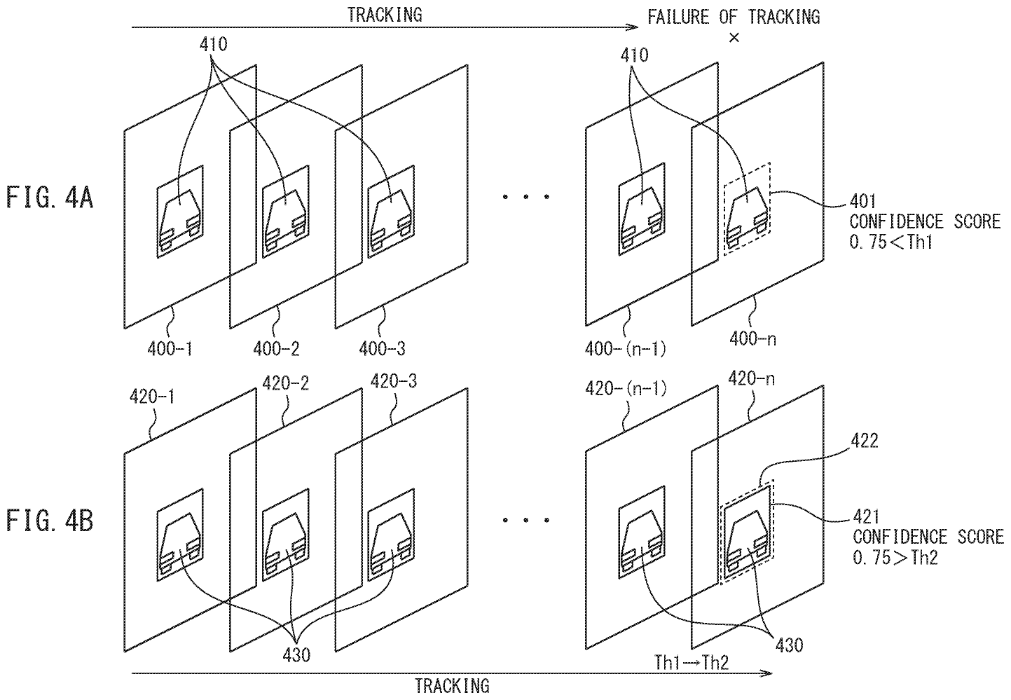

FIG. 4A is a schematic diagram for explaining a tracking process according to a comparative example. FIG. 4B is a schematic diagram for explaining the tracking process according to the present embodiment. In the example illustrated in FIG. 4A, a target vehicle 410 is represented in each of time-series images 400-1 to 400-n. However, the confidence score (0.75) calculated by the classifier for a region 401 representing the target vehicle 410 in the n-th image 400-n is less than a first value Th1 of the detection threshold. As a result, the target vehicle 410 is not detected in the image 400-n, which causes a tracking device according to the comparative example to fail to track the target vehicle 410.

In the example illustrated in FIG. 4B also, a target vehicle 430 is represented in each of time-series images 420-1 to 420-n. Assume that at the time of the (n−1)-th image 420-(n−1) the tracking count of the target vehicle 430 exceeds the predetermined number. Thus, in a low-threshold region 422 assumed to represent the target vehicle 430 in the n-th image 420-n, the detection threshold is changed from the first value Th1, which has been applied until the image 420-(n−1), to a second value Th2 lower than the first value. Therefore, even if the confidence score (0.75) for a region 421 representing the target vehicle 430 in the image 420-n is less than the first value Th1, the region 421 is detected as a candidate region in the case that the confidence score is not less than the second value Th2 and that the region 421 is included in the low-threshold region 422. As a result, the target vehicle 430 is kept tracked even in the image 420-n.

The vehicle control unit 34 generates one or more planned trajectories of the vehicle 10 by referring to the detection list so that the vehicle 10 will not collide with any target vehicle being tracked. Each planned trajectory is represented as, for example, a set of target positions of the vehicle 10 at points in time from the current time to a predetermined time ahead thereof. To this end, the vehicle control unit 34 sets the planned trajectory so that the vehicle 10 travels along a planned travel route set by the navigation device or along the lane on which the vehicle 10 is traveling. For example, the vehicle control unit 34 refers to the detection list to execute viewpoint transformation, using information such as the position at which the camera 2 is mounted on the vehicle 10, thereby transforming the image coordinates of the individual target vehicles being tracked into coordinates in an aerial image (“aerial-image coordinates”). To this end, the vehicle control unit 34 can estimate the position of a target vehicle being tracked at the time of acquisition of each image, using the position and orientation of the vehicle 10, an estimated distance to the target vehicle, and the direction from the vehicle 10 to the target vehicle at the time of acquisition of each image. The vehicle control unit 34 can estimate the position and orientation of the vehicle 10 by comparing an image generated by the camera 2 with the map information. For example, with an assumption about the position and orientation of the vehicle 10, the vehicle control unit 34 projects features on or near the road detected from the image onto the map information, or features on or near the road around the vehicle 10 represented in the map information onto the image. The vehicle control unit 34 then estimates the actual position and orientation of the vehicle 10 to be the position and orientation thereof for the case that the features detected from the image match those represented in a high-precision map the best. Additionally, the vehicle control unit 34 can identify the direction from the vehicle 10 to a target vehicle being tracked, based on the position of the region including the target vehicle in the image and the direction of the optical axis of the camera 2. For each target vehicle being tracked, the vehicle control unit 34 further estimates the distance from the vehicle 10 to the target vehicle, based on the ratio of the size of the region representing the target vehicle to a reference size, which is the size measured under the assumption that the distance between the target vehicle and the vehicle 10 is a predetermined distance. Alternatively, in the case where the vehicle control system 1 includes a range sensor (not illustrated), such as LiDAR or radar, the distance to each target vehicle being tracked may be measured with the range sensor. In this case, for example, the distance in the direction from the range sensor corresponding to that direction from the camera 2 which corresponds to the centroid of a region representing a target vehicle of interest in an image is measured as the distance from the vehicle 10 to the target vehicle of interest.

The vehicle control unit 34 executes a prediction process with, for example, a Kalman filter or a particle filter, on time-series aerial-image coordinates of a target vehicle being tracked to estimate a predicted trajectory of the target vehicle to the predetermined time ahead.

The vehicle control unit 34 generates a planned trajectory of the vehicle 10, based on the predicted trajectories of the target vehicles being tracked as well as the position, speed, and orientation of the vehicle 10, so that a predicted distance between the vehicle 10 and any of the target vehicles will not be less than a predetermined distance until the predetermined time ahead.

The vehicle control unit 34 controls components of the vehicle 10 so that the vehicle 10 will travel along the planned trajectory. For example, the vehicle control unit 34 determines the acceleration of the vehicle 10 according to the planned trajectory and the current speed of the vehicle 10 measured by a vehicle speed sensor (not illustrated), and sets the degree of accelerator opening or the amount of braking so that the acceleration of the vehicle 10 will be equal to the determined acceleration. The vehicle control unit 34 then determines the amount of fuel injection according to the set degree of accelerator opening, and outputs a control signal depending on the amount of fuel injection to a fuel injector of an engine of the vehicle 10. Alternatively, the vehicle control unit 34 determines the electric power to be supplied to a motor according to the set degree of accelerator opening, and controls a driving circuit of the motor so that the determined electric power will be supplied to the motor. Alternatively, the vehicle control unit 34 outputs a control signal depending on the set amount of braking to the brake of the vehicle 10.

When the direction of the vehicle 10 is changed in order for the vehicle 10 to travel along the planned trajectory, the vehicle control unit 34 determines the steering angle of the vehicle 10 according to the planned trajectory. The vehicle control unit 34 then outputs a control signal depending on the steering angle to an actuator (not illustrated) that controls the steering wheel of the vehicle 10.

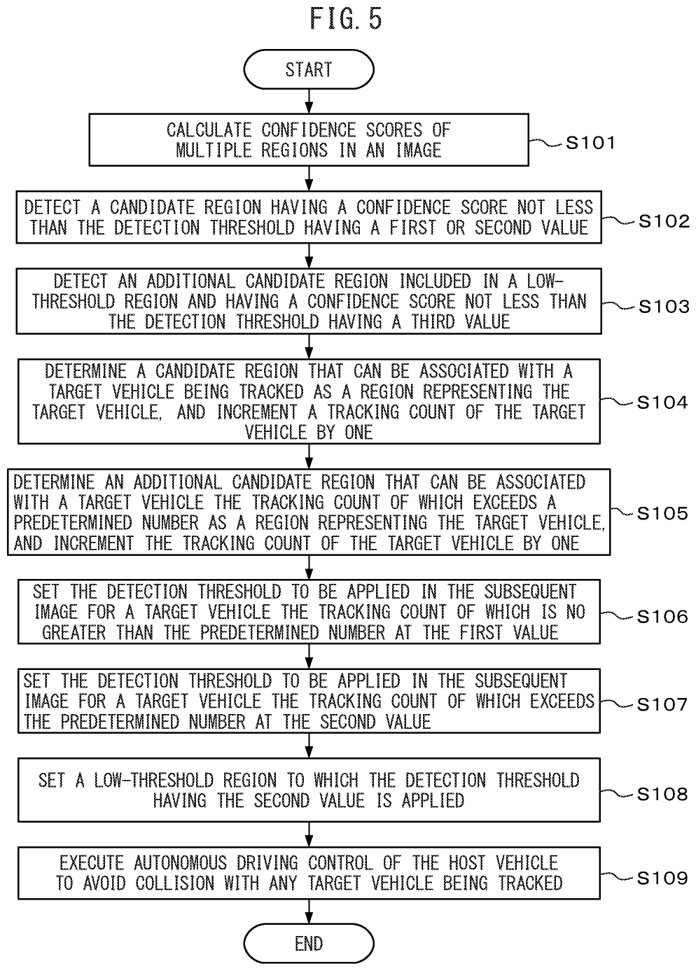

FIG. 5 is an operation flowchart of the vehicle control process executed by the processor 23 and including the tracking process. The processor 23 executes the vehicle control process in accordance with the operation flowchart illustrated in FIG. 5 at predetermined intervals. In the operation flowchart described below, the process of steps S101 to S108 corresponds to the tracking process.

The candidate region detection unit 31 of the processor 23 inputs the latest image obtained from the camera 2 into a classifier to calculate a confidence score for each of multiple regions in the image (step S101). The candidate region detection unit 31 compares the confidence score of each region with the detection threshold applied to the region. As described above, the candidate region detection unit 31 applies the detection threshold having a second value to regions each included in a low-threshold region and representing a target vehicle of the type applied to the low-threshold region, and applies the detection threshold having a first value to the other regions. The candidate region detection unit 31 then detects a region having a confidence score not less than the detection threshold as a candidate region (step S102). Also, in the case of multiple regions that have not been detected as candidate regions, the candidate region detection unit 31 detects a region included in a low-threshold region and having a confidence score not less than the detection threshold having a third value as an additional candidate region (step S103).

The tracking unit 32 of the processor 23 determines whether each candidate region can be associated with a target vehicle being tracked. The tracking unit 32 then enters a candidate region that can be associated with a target vehicle being tracked in a detection list in association with the target vehicle as an object region representing the target vehicle, and further increments a tracking count of the target vehicle by one (step S104). Further, the tracking unit 32 determines whether an additional candidate region can be associated with a target vehicle the tracking count of which exceeds a predetermined number. The tracking unit 32 then enters an additional candidate region that can be associated with a target vehicle the tracking count of which exceeds the predetermined number in the detection list in association with the target vehicle as an object region representing the target vehicle, and further increments the tracking count of the target vehicle by one (step S105).

The threshold control unit 33 of the processor 23 sets the detection threshold to be applied in the subsequent image for a track vehicle being tracked the tracking count of which is not greater than the predetermined number at the first value (step S106). The threshold control unit 33 also sets the detection threshold to be applied in the subsequent image for a target vehicle the tracking count of which is greater than the predetermined number at the second value lower than the first value (step S107). In addition, the threshold control unit 33 sets a low-threshold region to which the detection threshold having the second value is applied (step S108).

The vehicle control unit 34 of the processor 23 executes autonomous driving control of the vehicle 10 so that the vehicle 10 will not collide with any target vehicle being tracked (step S109). The processor 23 then terminates the vehicle control process.

As has been described above, the tracking device increments the tracking count of an object detected from time-series images and being tracked by one whenever the number of images in which the object can be tracked increases. Depending on the tracking count, the tracking device controls a detection threshold to be compared with a confidence score outputted by the classifier and indicating how likely the object to be detected is represented. In particular, the tracking device sets the detection threshold applied for an object the tracking count of which is greater than a predetermined number at a value lower than the value for the case that the tracking count is not greater than the predetermined number. This makes it easy for the tracking device to keep tracking an object even if it becomes difficult to detect the object from an image for some reason during tracking the object.

According to a modified example, the threshold control unit 33 may omit to set a low-threshold region when the position of the low-threshold region estimated for a target vehicle being tracked is outside the subsequent image. This is because in this case the target vehicle has probably moved to a position outside the area captured by the camera 2 by the time of generation of the subsequent image.

An object to be tracked is not limited to a vehicle, and may be another moving object that can be detected from an image, such as a human or an animal other than a human.

The tracking device according to the embodiment or modified example may be applied to equipment other than a vehicle control system. For example, the tracking device may be used for tracking an object represented in time-series images obtained by a surveillance camera placed for taking pictures of a predetermined outdoor or indoor region. In this case, the surveillance camera is an example of the image capturing unit.

The computer program for achieving the functions of the units of the processor 23 of the tracking device according to the embodiment or modified example may be provided in a form recorded on a computer-readable and portable medium, such as a semiconductor memory, a magnetic medium, or an optical medium.

As described above, those skilled in the art may make various modifications according to embodiments within the scope of the present invention.

What is claimed is:

1. A tracking device comprising:
a processor configured to:
detect at least one region having a confidence score not less than a predetermined detection threshold in an image generated by a camera as at least one candidate region by inputting the image into a classifier, the confidence score indicating how likely a predetermined object is represented,
determine whether one of the at least one candidate region can be associated with the predetermined object as a region representing the predetermined object, based on optical flow between an object region representing the predetermined object in a past image generated by the camera earlier than the image and each of the at least one candidate region,
increment a tracking count of the predetermined object by one when the association can be made,
set the detection threshold applied to a subsequent image obtained by the camera later than the image at a first value when the tracking count is not greater than a predetermined number, and
set the detection threshold applied to the subsequent image at a second value lower than the first value when the tracking count is greater than the predetermined number.

2. The tracking device according to claim 1, wherein the processor is further configured to
detect a region the confidence score of which is not less than a third value lower than the second value from the image as an additional candidate region when the tracking count is greater than the predetermined number, and
determine whether the additional candidate region can be associated with the predetermined object as a region representing the predetermined object, based on optical flow between the object region in the past image and the additional candidate region, when it is determined that none of the at least one candidate region detected from the image is a region representing the predetermined object.

3. The tracking device according to claim 1, wherein the processor is further configured to
estimate the position of the predetermined object in the subsequent image from the object region in each of past images generated by the camera earlier than the image, and
sets a region including the estimated position as a region to which the detection threshold having the second value is applied, the past images being generated while the predetermined object the tracking count of which is greater than the predetermined number is tracked.

4. A method for tracking, comprising:
detecting at least one region having a confidence score not less than a predetermined detection threshold in an image generated by a camera as at least one candidate region by inputting the image into a classifier, the confidence score indicating how likely a predetermined object is represented;
determining whether one of the at least one candidate region can be associated with the predetermined object as a region representing the predetermined object, based on optical flow between an object region representing the predetermined object in a past image generated by the camera earlier than the image and each of the at least one candidate region;
incrementing a tracking count of the predetermined object by one when the association can be made;
setting the detection threshold applied to a subsequent image obtained by the camera later than the image at a first value when the tracking count is not greater than a predetermined number; and
setting the detection threshold applied to the subsequent image at a second value lower than the first value when the tracking count is greater than the predetermined number.

5. A non-transitory recording medium that stores a computer program for tracking, the computer program causing a computer to execute a process comprising:
detecting at least one region having a confidence score not less than a predetermined detection threshold in an image generated by a camera as at least one candidate region by inputting the image into a classifier, the confidence score indicating how likely a predetermined object is represented;
determining whether one of the at least one candidate region can be associated with the predetermined object as a region representing the predetermined object, based on optical flow between an object region representing the predetermined object in a past image generated by the camera earlier than the image and each of the at least one candidate region;
incrementing a tracking count of the predetermined object by one when the association can be made;
setting the detection threshold applied to a subsequent image obtained by the camera later than the image at a first value when the tracking count is not greater than a predetermined number; and
setting the detection threshold applied to the subsequent image at a second value lower than the first value when the tracking count is greater than the predetermined number.
